(19) United States
(12) Patent Application Publication
(10) Pub. No.: US 2007/0220512 A1
(43) Pub. Date: Sep. 20, 2007

(54) Driver-Server for Data or Data Files of Device Drivers, Particularly Printer Drivers in a Computer Network

(76) Inventor: Ulrich Pfahler, Giebelstadt (DE)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/588,426

(22) PCT Filed: Jan. 25, 2005
(86) PCT No.: PCT/EP05/50309

§ 371 Date: May 9, 2007

(30) Foreign Application Priority Data
Feb. 9, 2004 (EP) 04 100477.1
May 14, 2004 (DE) 20 2004 007 955.0

(51) Int. Cl. G06F 9/445; G06F 3/12

(52) U.S. Cl. 717/177; 358/1.1

(57) ABSTRACT

The invention relates to an arrangement for distributing data for device drivers, particularly printer drivers, in a computer network, comprising three or more connected computers as nodes, of which at least one is connected as so-called peripheral server computer to one or more peripheral devices, for instance, printers, for administering and controlling said peripheral devices. At least two computers are provided with a corresponding driver server module, which is configured for receiving driver data or information for printer drivers or other device drivers and for the administration and transmission thereof to other computers. At least two driver server modules of different computer nodes communicate with one another and are hierarchically coupled to one anther in accordance with the master-slave principle. The computer nodes with the hierarchically subordinate driver sever module are connected to the at least one peripheral server computer in order to transmit driver data to said peripheral computer server.

### CROSS-REFERENCES TO RELATED APPLICATIONS

This application is a submission to enter the national stage under 35 U.S.C. 371 for international application number PCT/EP2005/050309 having international filing date 25 Jan. 2005, for which priority was based upon patent applications EP04100477.1, filed 9 Feb. 2004 in the European Patent Office and DE20 2004 007 955.0, filed 14 May 2004 in Germany.

### STATEMENT REGARDING FEDERALLY-SPONSORED RESEARCH AND DEVELOPMENT

### Not Applicable

### REFERENCE TO AN APPENDIX

### Not Applicable

### BACKGROUND OF THE INVENTION

1. Field of the Invention

The invention relates to an arrangement for distributing data for device drivers, in particular printer drivers, in a computer network, which has three or more connected computers as nodes. One of these takes the form of a peripheral server computer, which is connected to one or more peripheral devices, e.g. printers, for their administration and activation.

2. Description of the Related Art

In the Windows operating system by the firm Microsoft, it is known to use printer drivers for the printing of documents etc. which transfer Windows-internal data into a code which the printer can understand. In order to be able to print out on a printer, therefore, a printer driver adapted to the printer must always be installed on a print server made available by the operating system. With the administration tools known hitherto, the installation of a printer driver on a print server can only be carried out manually. There is therefore the disadvantage that human administrator intervention is always necessary in order to install the necessary printer driver on the print server. Since printer drivers are updated from time to time, in order for example to remove known faults from older driver versions, the need for manual installation or updating of drivers generates a considerable amount of work. This disadvantage is particularly serious for computer networks in which a large number of print servers are operated. In order to be able to install device drivers having their own installation programs remotely from a spatial distance via cables or communication connections, recourse must be had to technologies such as the Active Directory (component of Active Platform) which are known per se and which permit actual applications of location, use and administration of directory resources (e.g. user names, network printers and access rights) in a distributed environment. Although the distribution and installation of device drivers is thus in principle possible, it is laborious and complicated. Furthermore, the number of device driver data files to be distributed increases the quantity of data to be transferred out of all proportion.

The object of the invention is therefore to minimise the administrative complexity in the distribution of data for device drivers whilst avoiding the disadvantages of the prior art mentioned above. To achieve this, the distribution arrangement for device driver data in a computer network indicated in claim 1, the accordingly adapted computer node with a driver server indicated in claim 14, and the accordingly adapted peripheral server computer indicated in claim 20 having an automatic driver installation program are proposed. Within the scope of the general inventive notion are included also the computer programs indicated in claims 18 and 24 for realising a driver server module or a graphic user interface. Optional, advantageous embodiments will appear from the (dependent) subclaims.

### BRIEF SUMMARY OF THE INVENTION

On the basis of the invention, therefore, at least two computer nodes as so-called driver server computers are each provided with a driver server. The latter is formed for receiving data collections concerning driver software (programs, set of data, documents or the like being used thereby), whereby printers or other devices, in particular the computer periphery, can be operated. Further, the driver servers are also formed for administrating the driver data or information and for transferring these to other computers. According to the invention, at least two driver servers of different computer nodes are in communication with one another in a hierarchical manner according to the master/slave principle, in which the one dominates or controls the other.

In particular, the invention comprises the arrangement of computer nodes of a computer network, in which one or more driver servers and one or more peripheral (device) servers are arranged in a hierarchical structure for the purposes of automated driver distribution and driver installation. This includes driver server (modules) in particular software modules or function components implemented on network computer nodes, which are used to receive data files for printer or other drivers and to transfer or send these to one or more subordinate software modules and/or computer nodes. Peripheral servers are function components or software modules which are implemented on computer nodes and which are each connected to at least one peripheral device, e.g. printer, to activate the same.

With the invention, the advantageous possibility is opened up of making the automated transfer of driver data files from driver servers to subordinate driver and peripheral device servers take place controlled in a time-specific manner and/or only upon request. On the peripheral device servers, the transmitted or received driver data files can be used particularly advantageously for automatic installation of the device drivers if these contain their own installation programs.

On the basis of the invention, on certain servers of the computer network, a service is set up which knows, stores and can send to any number of servers via the network connecting the individual servers, all necessary data files (driver data files) and configuration settings or data files (e.g. stored in INF files known per se) for respective device drivers. To each device server or peripheral server, individually any device drivers can then be allocated, which are transferred in a time-controlled manner and at need automatically from the superordinate server and are installed on the peripheral server computer. Thus the administrative cost of the installation and the updating of device drivers including printer drivers in the computer network can be minimised.

The configuration settings or data files each relate to the settings of an individual driver. In particular these settings describe from which individual data files the driver is composed and how these are to be installed (sequence, target directories etc.). In addition, these settings contain information for identifying the driver uniquely (these unique identification features will be used later).

The service on the computer node which makes available the driver data files of device drivers is referred to below as the driver server. Computer nodes with the “driver server” service do not necessarily have to be used as peripheral servers, in particular print servers. Peripheral servers require for automatic installation of the device drivers a service which is referred to below as “driver installer”. Both services “driver server” and “driver installer” are available in the software package “Print Management Control” (PMC for short); a short description of this software package is attached.

The invention is based on the arrangement of driver servers in a hierarchical structure. This means that superordinate driver servers supply some of the available drivers to their subordinate driver servers, which send this in turn to their allocated peripheral server computers. Furthermore, subordinate driver servers can additionally make available further drivers, which are not available on the superordinate driver server. This arrangement of the driver servers in a hierarchical structure permits adaptation to the requirements of the driver installation in computer networks in particular of businesses. By this step-like automatic sending of driver data files, the quantity of data transferred through the network is advantageously reduced to a minimum.

According to an advantageous embodiment of the invention, by the allocation of a device driver by a driver server to a subordinate peripheral server computer, the device driver is installed automatically in a time-controlled manner by the driver installer service. It obtains the necessary data from its superordinate driver server. The administration of the hierarchical driver server structure, the device driver made available and the allocation of the device driver to peripheral server are effected via a graphic user interface, which can be implemented at any location in the computer network (central administration).

The hierarchical arrangement of the driver servers and/or use of the driver installers on the basis of the invention opens up the following advantageous possibilities:
minimisation of the administrative cost,
automatic installation of the device drivers on the peripheral server computers,
automatic updates of the device drivers if these are updated on the driver server,
availability of an auto-repair function, if driver data files are accidentally deleted or overwritten on a peripheral server computer,
minimisation of the occurrence of data in the computer network (e.g. with plural geographically remote locations) by use of the hierarchical structure.

The driver server according to the invention forms a central level for administration and automatic sending of device drivers to subordinate peripheral servers, which are formed according to an advantageous embodiment for realising the driver installers (module for automatic installation of a device driver). The driver servers may run on any computer node which may in principle act as a server. Plural driver servers may exist on one network, but a peripheral server can only ever obtain its device driver from one (superordinate) driver server. The driver server is advantageously programmed or set up to administrate the respective device driver assembly or grouping for any peripheral server.

The driver installer is used for automatic installation and for automatic updating of device drivers. Furthermore, it has an auto-repair functionality for already-installed device drivers. Manual installation and administration of device drivers on the peripheral server computers thus becomes completely redundant.

The use of driver servers on the basis of the invention additionally permits the inventorisation of all device drivers belonging to the computer network. A computer network so equipped can for example be used for supraregional management of the computer device resources of a business which operates distributed over different locations.

From the hierarchical structure of the arrangement of the driver servers, it follows that a so-called master driver server makes available some or all of its device drivers for one or more so-called slave driver servers. Thus a master driver server can be set up at a central point, which makes available to slave driver servers, e.g. in business branches at different locations, printer or other device drivers. These are then distributed in the respective branches to the peripheral server computers (optionally with a driver installer). This arrangement minimises the volume of data to be transferred in the computer network, which arises when device drivers are added or updated.

Furthermore, within the scope of an advantageous embodiment of the invention, the possibility exists that a slave driver server administrates its own drivers in its database in addition to the drivers allocated by the master driver server.

The driver server functionality and the driver installer functionality are independent of other functions of the abovementioned “Print Management Control” (PMC) explained in the appendix. According to one embodiment of the invention, all data files of the device driver are stored on a mass or background memory, e.g. hard disk of the computer node carrying out the driver server. The device drivers themselves do not need to be installed for the driver server. The driver server is therefore completely independent from any drivers which may be installed on the operating system of the computer node carrying out the driver server. This arrangement permits, in addition to the storage of plural versions of a device driver, the storage of device drivers which are not supported at all by the operating system within which the driver server is carried out.

On the other hand, it is within the scope of the invention that a driver server can also make available device drivers for itself. The driver server is then from the point of view of the driver server functionality both a driver server and also a subordinate driver installer, i.e. such a server carries out both the driver server service and the driver installer service.

According to an advantageous embodiment of the invention, the driver server—in addition to the data, data files or collections with driver information—provided with information or corresponding data or data files about a configuration in which it is established which device drivers are available, and in which path of the hard disk of the computer node carrying out the driver server the driver data files are stored. This configuration information, referred to below (unlike the configuration settings of individual drivers discussed above) as “grouping” or “assembly”, relate (in addition to further settings) to a plurality of device drivers, which are in turn to be uniquely identified (as discussed above). The individual settings for each device driver (“individual configuration file”) are meaningless for the grouping or assembly information of the driver server and driver installer. Both the driver-specific individual configuration and grouping or assembly information intended in common for the driver server and allocated to the plural device drivers are stored in data files. However, each one is a different file, with a different format and content.

In a further embodiment of the notion of the grouping or assembly are stored in the corresponding data file the name of the device driver, its version number, the operating systems supported by the device driver, the manufacturer of the device driver, a freely selectable commentary and further driver-specific attributes and the driver category. The driver category describes whether the device driver is a device driver allocated to a superordinate driver server, or whether the device driver is located on its own system hierarchically in the first position or in the case of a tree-like structure forms a root node. In a further embodiment of the data collection for this grouping or assembly, the names of subordinate driver servers and peripheral server computers can be stored, to which device drivers can be allocated. For each individual one of these servers, in the assembly organised preferably as a data file, it is recorded which of the already placed device drivers are allocated to the respective computer node or system.

Similarly, it is within the scope of optional embodiments of the invention if in the case of a peripheral server computer, one, more or all driver installers (driver installation modules) receive an assembly, in which is stored who the respectively superordinate driver server is, and at what time intervals the information or data files of the allocated device driver are to be updated. If the driver installer receives updated information for its allocated device drivers, it transfers the driver data files automatically from the driver server to the hard disk of the computer node executing it and installs the one or more device drivers. In addition, the driver installer carries out for each of the device drivers that it administrates a test as to whether the device driver is correctly installed. If necessary, an automatic repair of the device driver (repair installation) is carried out. According to a further embodiment of the invention, the driver installer stores the date and clock time when each allocated driver was last installed.

In order to simplify operation and increase user-friendliness, within the scope of the general inventive notion, the graphic user interface already discussed above is set up adapted to the function of the invention. Via this human-machine interface, all settings of driver servers and/or driver installers can be carried out.

### BRIEF DESCRIPTION OF THE SEVERAL VIEWS OF THE DRAWINGS

Further features, combinations of features, effects and advantages of the invention will appear from the following description of preferred embodiments of the invention and from the drawings, which show by respective schematically simplified representation in

FIG. 1 the hierarchical arrangement of the driver servers with peripheral server computer (“print server”) and driver installer (automatic installation module) allocated thereto as a block diagram,

FIG. 2 the information or data streams for administrating the driver servers and installers in combination with a module for realising a graphic user interface as a block diagram,

FIG. 3 a concrete realisation of the graphic user interface by means of a screen detail for administrating the arrangement of the driver servers according to the invention, and

FIG. 4 the detail IV from FIG. 3 on a larger scale.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

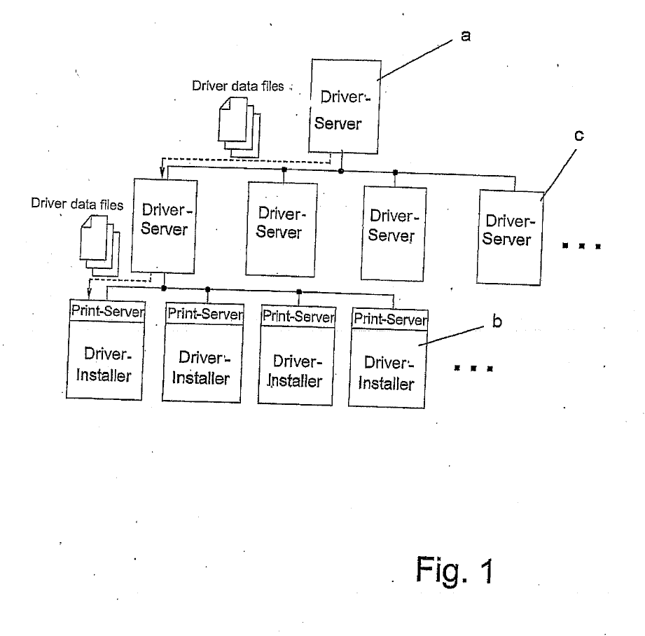

FIG. 1 illustrates in a computer network with a plurality of computer nodes (e.g. one computer node per block) the hierarchical arrangement of the driver servers and peripheral servers, the latter referred to in the example drawn as “print servers”. In the tree structure used, in the place of the root node, a computer node a with a master driver server implemented thereon on the first level is used in order to make available driver data files for device drivers, in particular printer drivers. If the computer network drawn is used for a supraregionally active business, printer drivers can thus be distributed to individual business branches with a print server available at each, implemented on a peripheral server computer node b. For such distribution, an intermediate level is also necessary, in particular the computer node c with the slave driver server respectively implemented thereon. The uppermost level is formed by the computer node a with the master driver server, and the middle level by the computer node c with the respective slave driver server. By allocating certain printer drivers or other device drivers to the subordinate slave driver server (from the master driver server), which are located at regionally or geographically distributed locations, the driver data files are automatically and once only transferred to the subordinate slave driver servers and are stored there (middle level or intermediate level in FIG. 1). The peripheral server computer nodes b with the respective print server or other device server of each individual business location then receive their driver data files from the local (slave) driver server. The driver installer services (module for automatic installation) respectively implemented on the peripheral server computer nodes b install the printer or other device drivers allocated thereto automatically on the respective peripheral server computer nodes b of the lowest level.

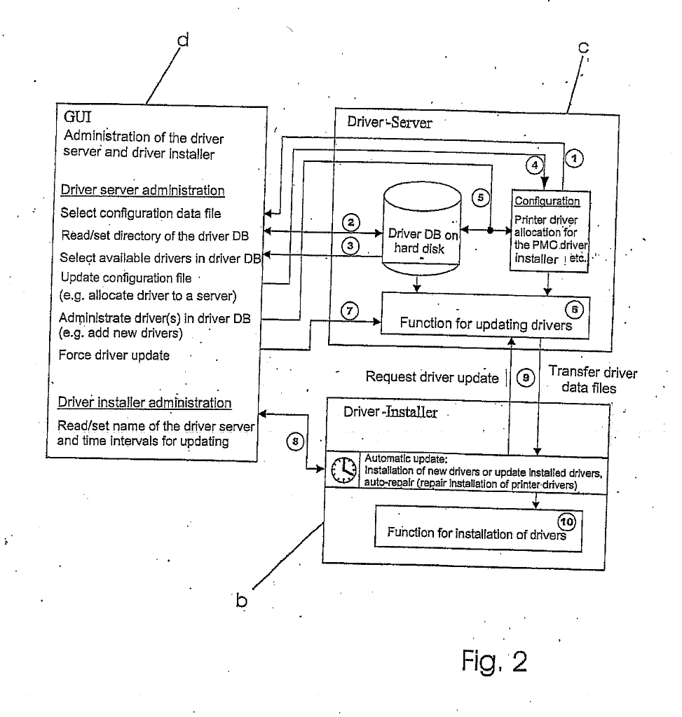

According to FIG. 2, in order to administrate the driver server modules and the driver installation modules, the graphic user interface GUI is used, which can be implemented on its own computer nodes b, just like the driver servers on the slave computer nodes c and the peripheral servers on the peripheral server computer nodes b. The driver installer running on the peripheral server computer node b (driver installation module) can be provided with a Windows Print server known per se.

The significance and function of the communication paths provided in FIG. 2 with reference numbers 1-10 and sub-blocks or submodules 6, 10 is as follows:
1- Transfer of a grouping and/or assembly data file (called “configuration” in FIG. 2) from the driver server computer node c to the GUI computer node d;
2- Placing of a directory in a driver database, which can be implemented on the hard disk of the driver computer node (master driver or slave driver according to FIG. 2); the driver data files are also stored in this database DB;
3- Selection of information of the printer driver or other device driver made available on the database DB;
4- Configuration and maintenance of the hierarchical arrangement of the driver servers and driver installers, in particular placing of the settings of the individual systems, allocation of printer drivers or other device drivers or the like;
5- Addition of printer driver data files in the driver database of the driver server;
6- Program thread for communication in particular for the purpose of transfer of driver data files via the computer network to the peripheral server computer node b and for communication with the driver installer implemented thereon;
7- manual forcing of the immediate updating of a driver installer;
8- placing or maintenance of the name of the allocated driver server and of the time intervals for automatic updating;
9- automatic updating of a driver installer;
   connecting to the driver server for updating, balancing of the grouping or assembly data;
   transfer of the necessary driver data files in order to re-install printer or other device drivers or to carry out a repair installation;
10- Program thread for installation of a printer or other device driver with the driver data files transferred by the driver server

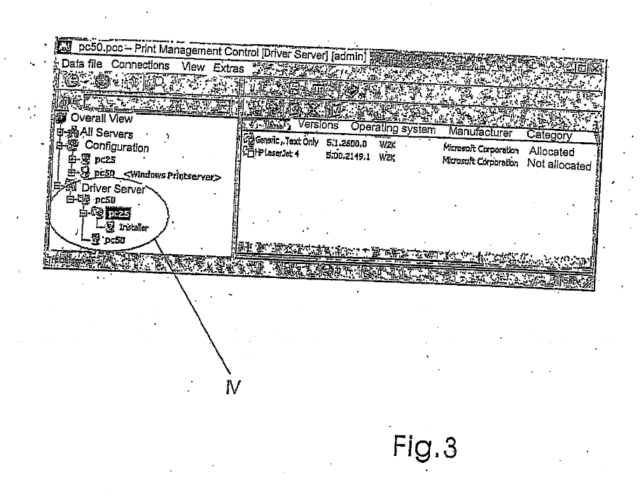

According to FIG. 3, by means of a graphic surface via a snap-in within the circle shown, the hierarchical arrangement of the driver servers and driver installers is shown. The driver servers and the driver installers can be administrated via this snap-in of the GUI computer node d. The GUI module makes available a graphic interface for the system administrator, whereby all relevant information about servers of the computer network is presented in a suitable manner. The graphic interface can be configured or set up to be understood internationally, in that all the indicated texts are made available in the respectively desired language.

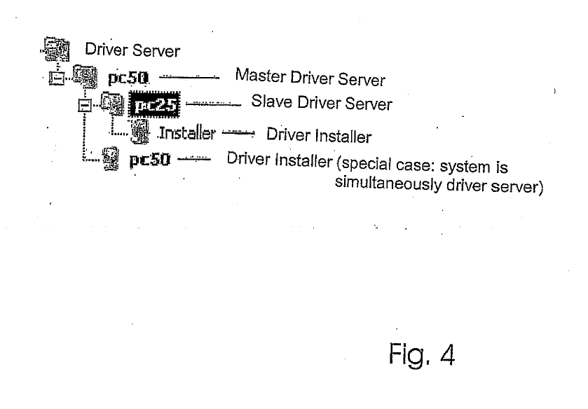

In the tree view according to FIGS. 3 and 4 on the graphic user interface GUI, the hierarchical arrangement of the driver servers and of the driver installers is shown. Any number of further server computers can be subordinated to each driver server as slave driver servers or driver installers on computer nodes for driver servers or peripheral servers. These are then shown according to FIGS. 3 and 4 moved in below the driver server (with different icons, dependent on their functionality).

If a driver server is selected, in the detail view the driver located in the driver database is listed. Here, further drivers can be added or drivers not being used can be deleted. Allocations of drivers to a plurality of subordinate driver servers and driver installers can be carried out at a central point in this advantageous embodiment of the invention.

When a driver installer or subordinate driver server is selected, the drivers made available are indicated in the detail view. In this case, allocations of individual drivers can be set up or cancelled, and in addition updates of drivers can be initiated.

### LIST OF REFERENCE NUMBERS

a root computer node
b peripheral server computer node
c slave driver server computer node
d GUI computer node
GUI graphic user interface

1. An arrangement for distributing data for device drivers, in particular printer drivers, in a computer network, which has three or more connected computers as nodes (a, b, c, d) of which at least one is connected as a so-called peripheral server computer (b) to one or more peripheral devices, for their administration and activation, characterised in that at least two (a, c) of the computers are each provided with a driver server module, which is formed for receiving driver data or information for printer or other device drivers and for their administration and transfer to other computers (b, d), and are in communication with at least two driver server modules of different computer nodes (a, c) and are thus dominatingly coupled hierarchically with one another according to the master/slave principle, and the computer node (c) is connected by the hierarchically subordinate driver server module to the at least one peripheral server computer (b) for transferring the driver data to the latter.

2. An arrangement according to claim 1, characterised in that the driver server modules of one or both computers (a, c) are formed for receiving individual configuration data files or data sets for setting a printer or other device driver, and for administrating and transferring these configuration data files or data sets to other computers (b).

3. An arrangement according to claim 2, characterised in that the peripheral server computer (b) or at least one computer (a, c) is provided with a driver server module having one or more modules for automatically installing one device driver each.

4. An arrangement according to claim 2, characterised in that the peripheral server computer (b) is arranged by programming to request as a client from the driver server module communicating therewith, data for device drivers or configurations automatically or by user input or to receive the same upon update initialisation of a driver server module.

5. An arrangement according to claim 4, characterised in that a driver server module which is superordinate to another is coupled to a memory of a predetermined quantity of different device driver and/or device configuration data and is set up to transfer to the subordinate driver server module only part of the stored device driver data and/or configuration data.

6. An arrangement according to claim 2, characterised by a computer node (d) provided with a graphic user interface (GUI) for the central administration of the hierarchical transfer and distribution of the device driver data and device configuration data between the computer nodes (a, b, c, d) including the peripheral server computer (b) or between the driver server modules and the installation modules on the peripheral server computers (b).

7. An arrangement according to claim 2, characterised by an auto-repair module, which is in communication with the peripheral server computer(s) (b) and at least one of the driver server computer nodes (a, c), which is set up and formed for fault recognition and elimination thereat by repeated transmission of driver data or individual configuration data files for printers or other devices.

8. An arrangement according to claim 2, characterised by a tree-like structure of the computer nodes (a, b, c), the uppermost node or root node (a) being provided with a master driver server module, which dominates all further slave driver server modules connected thereto of downstream computer nodes (c) in the master/slave hierarchy in order to transfer data for device drivers and configurations of the computer network thereto.

9. An arrangement according to claim 8, characterised in that the master driver server module (a) and the slave driver server module (c) are each provided with a memory region (DB) for inventorying and sending data for all device drivers and configurations of the computer network.

10. An arrangement according to claim 8, characterised in that the peripheral server computers (b) form the lowest level or the lowest or end nodes of the tree-like structure.

11. An arrangement according to claim 8, characterised by a plurality of driver server modules of the same order in the hierarchy or computer nodes (c) provided therewith, with which one or more peripheral server computers (b) communicate in order to receive device driver data or device configuration data.

12. An arrangement according to claim 8, characterised in that a subordinate slave driver server module or a computer node (c) provided therewith is provided with data for device drivers and device configurations of the computer network, which are different from those of the superordinate master server driver module or of the computer node (a) provided therewith.

13. An arrangement according to claim 8, characterised in that at least one of the computer nodes (a, c) having a respective driver server module is provided itself with one or more modules for installation of a respective device driver.

14. An arrangement according to claim 8, the arrangement including a computer node (a, c) with a driver server module, having a local, non-volatile permanent memory (DB), characterised by saving of the device driver data and optionally of the individual configuration data files for printer or other device drivers entirely or in part in the permanent memory (DB), and by a driver grouping or assembly data file further saved therein having data representing the information about a directory of device drivers or device individual configurations kept available, about memory locations for the driver data or individual configuration data files, about allocations of the device drivers to peripheral server computers (b) or other peripheral components or about names or addresses of hierarchically subordinate driver server modules or computer nodes (c) or peripheral server computers (b) provided therewith.

15. An arrangement according to claim 14, wherein the computer node is characterised in that in its permanent memory a database (DB) is applied, in which driver or configuration data of different printer or other different device drivers are saved.

16. An arrangement according to claim 14 wherein the computer node is, characterised in that thereon the stored device driver data or device configuration data are at least partially not installed or not capable of running.

17. An arrangement according to claim 14 wherein the computer node is characterised in that at least part of the device drivers stored on the computer node (a, c) and administrated by the driver server module thereon is not compatible with the operating system of the computer node (a, c).

18. An arrangement according to claim 5 and further comprising a computer program for realising the driver server module on a computer node (a, c), characterised by program code elements for carrying out the said functions of the driver server module.

19. An arrangement according to claim 18 wherein the program code elements are loaded in a computer memory, stored on a computer-readable data carrier, or are contained in an electrical carrier signal so as to be downloadable.

20. An arrangement according to claim 1, wherein the peripheral server computer (b), has one or more modules for automatic installation of a respective device driver, characterised in that the at least one driver installation module is coupled to a memory region for a grouping and assembly data file, whose data represent information at least about a driver server module allocated to or superordinate to the driver installation module.

21. An arrangement according to claim 20, characterised in that the assembly data file contains information about time intervals within which received or allocated device drivers are to be updated.

22. An arrangement according to claim 21, characterised in that the driver installation module is formed with a functionality for monitoring device driver installations for accuracy.

23. An arrangement according to claim 21, characterised in that the driver installation module is formed with an auto-repair routine which may be triggered by the fault monitoring functionality for the repair installation of a device driver concerned.

24. An arrangement according to claim 6 and further comprising a graphical user interface (GUI), characterised by the driver server modules or the computer nodes (a, c) provided therewith and read and write interfaces allocated to the peripheral server computers (b) for carrying out functions of administration of plural driver server modules, in that these interfaces are formed for access to memory regions (DB) which act as sources or sinks for data of the device drivers or configurations for the driver server modules or the computer nodes (a, c) provided.

25. (canceled)

26. (canceled)
